(19) United States
(12) Patent Application Publication
(10) Pub. No.: US 2008/0190694 A1
(43) Pub. Date: Aug. 14, 2008

(54) Multifunctional Holding Device

(76) Inventor: Hermann Niklas, Johann-Gruber-Sir (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/885,667

(22) PCT Filed: Mar. 15, 2006
(86) PCT No.: PCT/DE06/00459

§ 371 Date: Sep. 5, 2007

(30) Foreign Application Priority Data
Mar. 15, 2005 (DE) 10 2005 011 724.4

(51) Int. Cl. E06C 7/14

(52) U.S. Cl. 182/129; 248/210

(57) ABSTRACT

The invention relates to a single- or multiple- or multifunctional holding device that is designed in such a manner that it can be fastened to a support in different ways and can in turn be used as the support for a second object. Differently shaped receiving sections, produced by the arrangement of the structural units in the form of U-shaped hooks, L-shaped hooks, connecting elements and connecting sections in relation to each other allow for the holding device to be fastened to differently shaped supports in a rotationally fixed manner by jamming, blocking, encompassing, engaging behind or positively resting against them and to be used as a support for other objects.

### BACKGROUND OF THE INVENTION

The invention relates to multifunctional holding devices for toolless attachment to frames, especially ladders, stringers, steps of stepladders or ladder rungs, and for accommodation of working devices without fasteners, for example tools, storage boxes, buckets and the like, with rod-shaped, bar-shaped or plate-shaped holding parts, which have with one another to a frame-shaped article with hook elements for hanging of the holding parts on the frame and for accommodating working devices [sic], the hook-shaped elements coming into contact with the respective parts of the frame, for example stringers, steps or rungs and being supported on these parts.

Hooks or holding devices of most varied type have become known. The main use of hooks or holding devices consists in hanging an article or attaching it in some way. The simplest and most common execution of a hook is S-shaped, consists of metal, and can be used in a versatile manner for simple purposes.

In order to perform special tasks however, numerous other hook-shaped articles and holding devices have been developed.

According to DE 299 10 008 U1 a holding device is placed over the beam on the rung of a ladder. A support arm which proceeds from the holding device is used in this connection as a receiver for a bucket. The disadvantage of this execution is that it can only be used on a limited basis, since both a stringer and also a rung of a ladder are required for hanging. Furthermore the holding receiver on which the bucket can be hung is far from the ladder so that the center of gravity of the bucket is displaced three-dimensionally away from the ladder. The resulting lever action can lead to the construction bending under a greater load, or the position of the ladder becoming unstable. Especially when the device is hung on the side of a ladder facing the user can this constitute a real danger.

In another type of hanging device as claimed in DE 299 00 960 U1 it is important that the hanging device is adjustable and can be matched to the respective width of the ladder stringer in order to hand a so-called rung cutout on the rung or that the hanging device can be placed on one step. In this connection the decisive feature is considered to be the installation of a pivoting support and blocking lever which in the working position on a connecting joint of a stepladder is used as a support or block against the device possibly sliding out of the stringer region of the stepladder. In this adjustable hanging device what is important is first of all achieving a variable region to which a hanging device can be attached using two stringer enclosures which can be adjusted to one another. In this connection a segment cutout holds another segment insert, and the two parts can be adjusted to one another for matching of the thickness of the stringer. In this hanging device in spite of complex production (cutting, drilling, thread cutting, fitting of segments and rung jaws) a device which may not be unconditionally safe in all applications in its stability and safety is formed.

Examples of rod-shaped holding devices according to the generic execution of this invention include U.S. Pat. Nos. 5,957,238, 6,131,699, 6,250,595 B1, UK patents 213082 A, 2353064 A, 2375570 A, DE 2121131 OS and U.S. Pat. No. 1,811,065 which relate to rod-shaped holding devices for use in conjunction with ladders and buckets or the corresponding vessels which can be attached to the ladders. These configurations of holding devices are all limited in their possible application to holding devices with a use which does not enable multifunctional uses.

It is an object of the invention is to devise holding devices for different applications which are as simple and versatile, therefore as multifunctional as possible, in their construction.

### SUMMARY OF THE INVENTION

As claimed in the invention, for generic holding devices it is suggested that two multiple hook arrangements which are made in parallel planes and which are spaced apart from one another consist of one continuous horizontal middle rod each with upper U-shaped hooks and lower U-shaped or L-shaped hooks made on the two rod ends, the multi-hook arrangements each on the side of the planes which is pointed away from the middle rod having an open site between the opposing hook legs for insertion or attachment of the holding device on the frame. Selectively on the face-side ends of the multi-hook arrangements with the middle rods cross connectors are additionally attached which fix the multi-hook arrangements and which on their outer ends each have one L-shaped hook at a time.

The important advantages of the invention are that in addition to improving the hanging and holding action of a conventional hook, a host of possibilities is created for attaching, fastening or fixing the holding device by a resting, clamping or tilting action on a device which is generally called a frame, especially a ladder or its stringer, step or rung or also on a lashing device. For this purpose the individual component regions or sections of the holding device are made with hooks for achieving the object such that they are arranged symmetrically and/or parallel, or also asymmetrically at a given distance to one another, also in pairs. The type of selected execution ensures that the hook or holding device in addition to its conventional function of a hanger is additionally placed or slipped onto a frame, for example a stringer, a step or a rung of a ladder or the like at a distance which is not defined in detail to the latter, or at least partially surrounds or extends behind this device or parts of it so that twisting around a cross sectional diagonal, for example of a stringer, a step or a rung is prevented by tilting, clamping, positive contact or locking, and on at least one part of the hook device or holding device a working device, for example a tool, a bucket, or the like can be securely hung or attached.

Another advantage of the invention is that two U-shaped component regions of the hook device or holding device which are located essentially parallel to one another for conventional hanging over a rung in the region of the ladder stringer act to stabilize in all three axes or counteract twisting. Moreover the holding device can be easily and reliably attached without adversely affecting operation and safety on both sides of the ladder, both on the side facing the user and the side facing away from the him.

Furthermore the invention enables the holding device to be placed or slipped onto a rung or the articulated part which connects the stringers of a stepladder along the lengthwise axis of the connecting region. In this respect it is especially beneficial that a large region at least in two axes comes into contact with them, protected against turning. Furthermore the articulated part is at least partially surrounded; this leads to high stability and outstanding holding capacity. Even larger loads can be easily affixed by this holding capacity, stable execution and closeness to the object.

When the holding device is slipped or hung on a rung or the step of a stepladder, it is possible to set the tool, for example in the form of a bucket, on the underlying rung or step so that only the handle of the bucket need be hung to protect against tipping. This has the major advantage that the weight of the tool is attached not laterally outside the ladder, but always over the ladder and thus tipping of the ladder even under greater loads can be avoided or at least reduced. If a bucket is hung on the uppermost step of a stepladder, it assumes an ideal and safe working position because it can be optimally reached by the worker when he is standing on the opposite side of the ladder.

Also in the case of a holding device hung on the top connecting stringer of two lateral stringers of a one-sided stepladder can the tool be optimally positioned for hanging a bucket or for pushing a resting surface into the hook and the bucket or the tool placed on the working surface can always be safely reached.

With a hose clamp fitting or cable clamp fitting the multifunctional hook itself can be attached quickly and safely and can be used to hang many different devices. Thus the tool for example can likewise be easily hung on a post or a handle. Accordingly a series of tools can be comfortably hung and carried along on a lashing belt or belt using the holding device.

### BRIEF DESCRIPTION OF THE DRAWINGS

The invention and its practical use are explained below in conjunction with the drawings using embodiments.

FIG. 1 shows in a perspective of one embodiment of a multifunctional holding device;

FIG. 2 shows in a side view a one-sided stepladder, on the top intermediate part of the lateral stringers of which a multifunctional holding device, as shown in FIG. 1 is hung;

FIG. 3 shows a perspective of a combined stepladder in which a stepladder and a rung ladder are movably connected to an articulated region. On the topmost step of the stepladder a multifunctional holding device is hung;

FIG. 4 shows in a perspective view of the lower rung of a ladder a holding device which is hung vertically offset by 90° to the step of the stepladder as shown in FIG. 3;

The perspective in FIG. 5 shows a holding device 1 which has been slipped on in the articulated region of a stepladder;

The holding device 1 as shown in FIG. 6, which is hung with a U-hook on a rung of a ladder;

FIG. 7 shows in a perspective view a combined stepladder with one section consisting of a stepladder and its other section of a rung ladder;

FIG. 8 shows a holding device on a rung of a ladder with hooks, which are made flat in an L shape at a connecting site connected to a U-hook;

FIG. 9 shows one embodiment of a holding device that is fixed on a tubular tool or on which a tool is fixed with a fastener;

The embodiment as shown in FIG. 10 shows how a holding device can be hung on a lashing belt or a belt;

FIG. 11 shows a cross sectional diagonal of a rung of a ladder on which the holding device is fixed;

FIG. 12 shows the cross sectional diagonal of a step of a stepladder;

FIG. 13 shows the cross sectional diagonal of the articulated region of a ladder;

FIG. 14 shows a cross sectional diagonal of an intermediate part or of a lateral stringer of a stepladder or a rung ladder; and

The photographs in FIGS. 15-26 show various practical applications of the holding device of the invention in conjunction with ladder rungs, ladder stringers, etc.

### DETAILED DESCRIPTION OF THE INVENTION

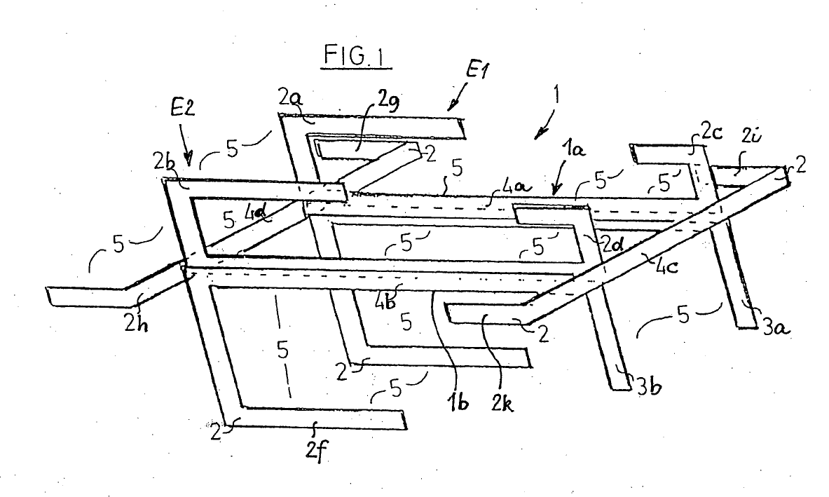

FIG. 1 shows in a perspective of one embodiment of a multifunctional holding device 1 as claimed in the invention. The holding device 1 consists of two holding elements 1a and 1b which are located in two parallel planes E1 and E2 and which each consist of a frame-like article which is composed of U-shaped hooks 2a, 2b on one end and U-shaped hooks 2c, 2d on the other end of a horizontal middle support 4a, 4b as the top section, and U-shaped hooks 2e and 2f on one end and L-shaped hooks 3a, 3b on the opposite end. These hook parts 2, 3 form receiving, attachment and hanging regions 5 which are assembled, for example welded together, by the U-shaped hooks 2 and L-shaped hooks 3 which are located parallel, symmetrically or asymmetrically to one another to form the entire holding device 1. In addition, as shown in FIG. 1, there can be cross connectors 4c, 4d, which are connected, preferably welded to the holding elements 1a, 1b at the height of the middle bars 4a, 4b, and which have L-shaped hooks 2f, 2g on their ends in order to achieve other hook devices.

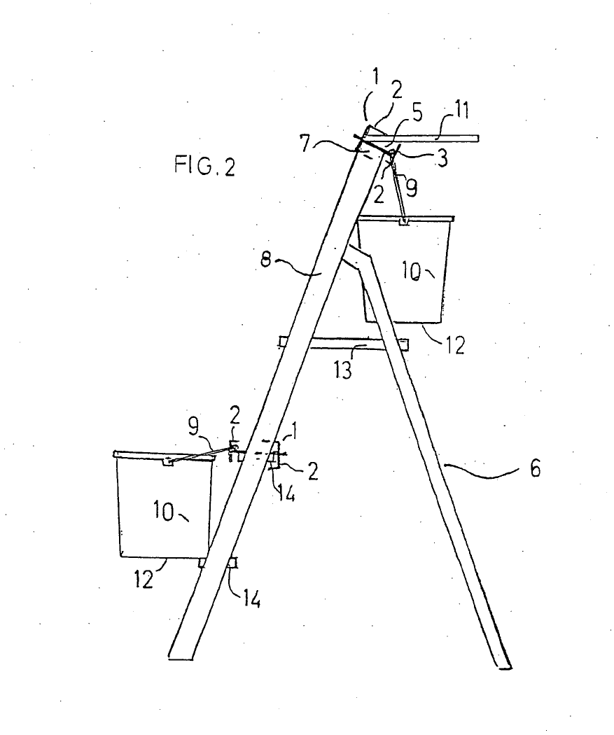

FIG. 2 shows in a side view a one-sided stepladder 6, on the top intermediate part 7 of the lateral stringers 8 of which a multifunctional holding device 1 as shown in FIG. 1 is hung or slipped, and the handle 9 of a bucket 10 can be hung both on a U-shaped hook 2 and also on an L-shaped hook 3. Furthermore the tool 11 is inserted under a U-hook 2 in a receiving, attachment or hanging region 5 and is held or supported by an L-hook 3. At a sufficient height of the bucket 10 the bottom 12 of the bucket can be rested on the platform 13 of the one-sided stepladder 6. The lower part of FIG. 2 shows a multifunctional holding device 1 which with a U-hook 2 extends around the step of a stepladder 14 of a one-sided stepladder 6, on another U-hook of the holding device 1 the handle 9 of a bucket 10 being hung, and the bottom 12 of the bucket is placed on the step 14 of the stepladder 6.

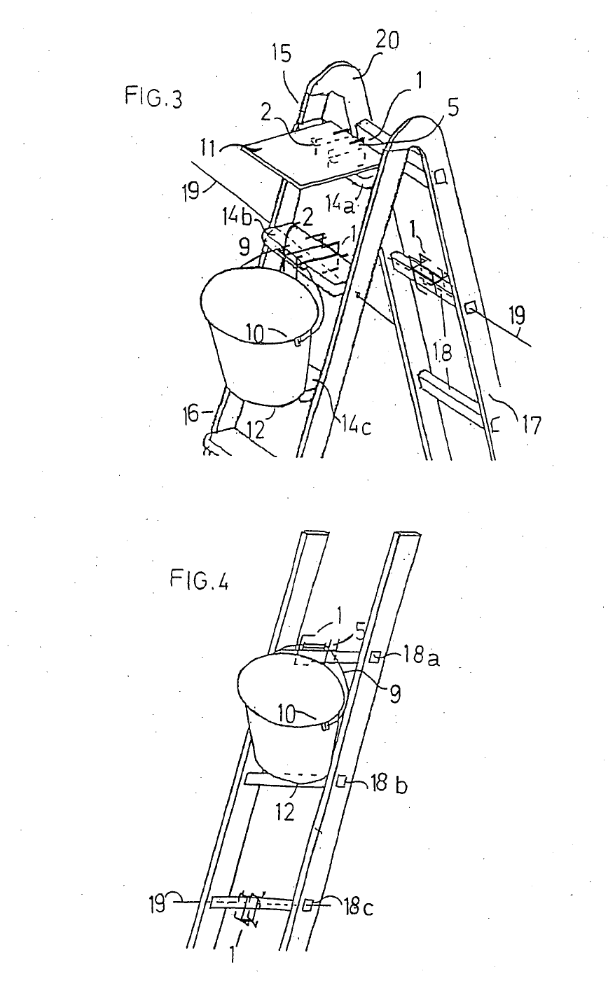

FIG. 3 shows a perspective of a combined stepladder 15 in which a stepladder 16 and a rung ladder 17 are movably connected to an articulated region 20. On the topmost step 14a of the stepladder 16 a multifunctional holding device 1 is hung or slipped. In the receiving, attachment and hanging region 5 a tool 11 in the form of a horizontal resting surface 11 is inserted and fixed on the U-hook 2. On the second highest step 14b a multifunctional holding device 1 is hung or slipped, the handle 9 of a bucket 10 being hung in two U-hooks 2 and the bottom 12 of the bucket 10 sitting on the step 14c underneath. Furthermore, FIG. 3 shows a multifunctional holding device 1 which has been slipped on one rung 18 of the stepladder 15 and which with reference to the holding device 1 slipped on the step 14b is seated horizontally by 90° to the lengthwise axis 19 of the step 14b on the rung 18.

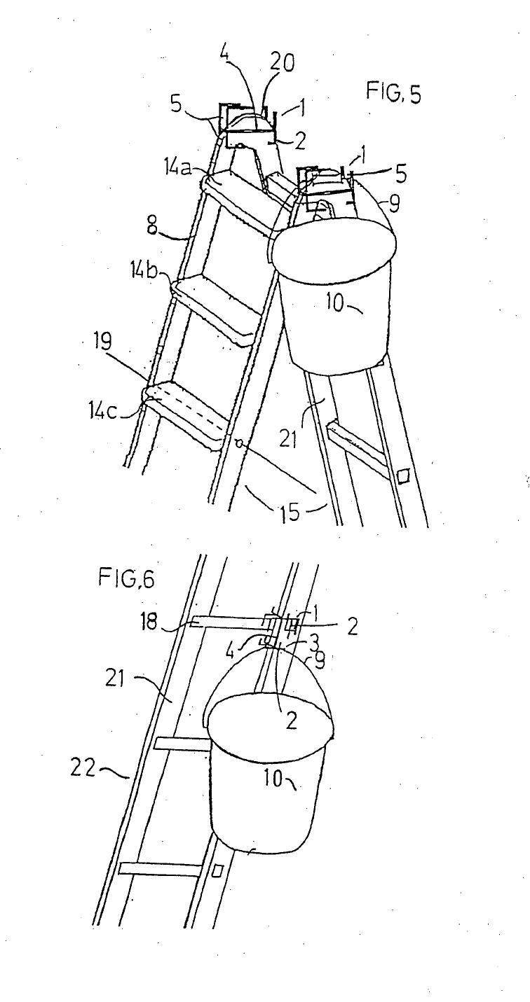

FIG. 4 shows in a perspective view of the lower rung 18c of a ladder a holding device 1 which is hung vertically offset by 90° to the step 14a of the stepladder 16 as shown in FIG. 3. Furthermore, FIG. 4 shows a holding device 1 which has been slipped onto the topmost rung 18a; in the receiving, attachment and hanging region 5 of the device the handle 9 of a bucket 10 is hung, and the bottom 12 of the bucket 10 sits underneath on the rung 18b.

The perspective in FIG. 5 shows a holding device 1 which has been slipped on in the articulated region 20 of a stepladder 15 and which with its connecting parts 4 rests both on the articulated region 20 and also laterally adjoining, with hooks 2 which form a receiving region 5, and extend around the stringers 8, 21 of the stepladder 15 or its articulated region 20 and are supported thereon against twisting. Furthermore, FIG. 5 shows a holding device 1 with the handle 9 of a bucket 10 hung in its receiving region 5.

The holding device 1 as shown in FIG. 6 which is hung with a U-hook 2 on a rung 18 of a rung ladder 22 is fixed such that two U-hooks 2 and two L-hooks 3 at a time laterally encompass the stringer 21 of the rung ladder 22 and protect it against twisting by tilting, the connecting parts 4 coming into contact with the stringer 21 in a stabilizing manner. Furthermore FIG. 6 shows that the handle 9 of a bucket 10 is hung in a U-hook 2 of the holding device 1.

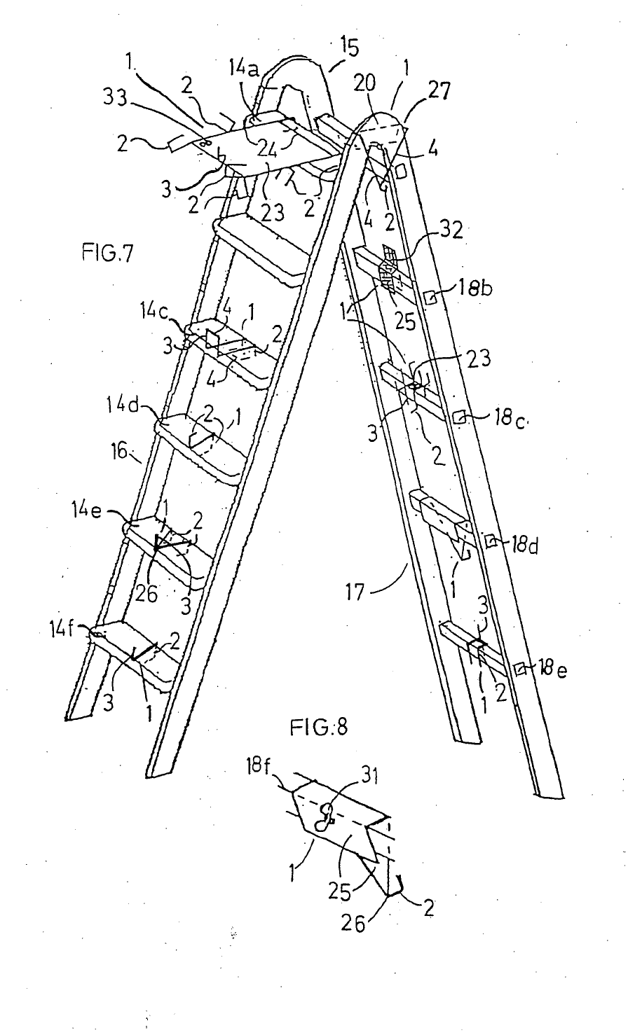

FIG. 7 shows in a perspective view a combined stepladder 15 with one section consisting of a step ladder 16 and its other section of a rung ladder 17. On the topmost step 14a of the stepladder 16 a holding device 1 is hung or slipped. In this regard the connection region 23 is made flat. On the edges 24 of the connecting region 25 U-hooks 2 or L-hooks 3 are attached at any positions. Furthermore FIG. 7 shows on the step 14c of the stepladder 16 a holding device 1 which has been hung or slipped on, with U-hooks 2 and L-hooks 3 running parallel to one another and with the respective ends connected to a connecting part 4. On the step 14e of the stepladder 16 a holding device 1 is shown slipped or hung, in which two U-hooks 2 are connected to only one L-hook 3 at one connecting site 26 at only one point. On the lowermost step 14f of the stepladder 16 a single (instead of a double) holding device 1 is shown in which only one U-hook 2 and one L-hook 3 at a time without a connecting part 4 are joined to one another. This holding device is made in one piece. Furthermore, FIG. 7 shows on the step 14d of the stepladder 16 a single holding device 1 in which two U-hooks 2 are joined to one another without a connecting part 4 and which is made in one piece. On one rung 18e a holding device 1 of U-hooks 2 or L-hooks 3 which are made rod-shaped is shown. The embodiment of the holding device 1 of U-hooks 25 and L-hooks 32 which are made flat is shown on one rung 18b. On the rung 18c of FIG. 7 another version of a holding device 1 is shown with U-hooks 2 and L-hooks 3 which are made rod-shaped, while their connecting region 23 is made flat. Another embodiment of a single holding device 1 of rod-shaped material is shown hung on a rung 18d. Finally, FIG. 7 shows on the articulated region 20 of a combined stepladder 15 a holding device 1 which is hung and which consists of a U-hook 2, connecting parts 4 and another U-hook 27 which is made selectively flat or rod-shaped.

FIG. 8 shows a holding device on a rung 18f of a ladder with hooks 25 which are made flat in an L shape at a connecting site 26 connected to a U-hook. On the flat hook 25 an adjusting or locking device 31 in the form of a thumb screw is attached.

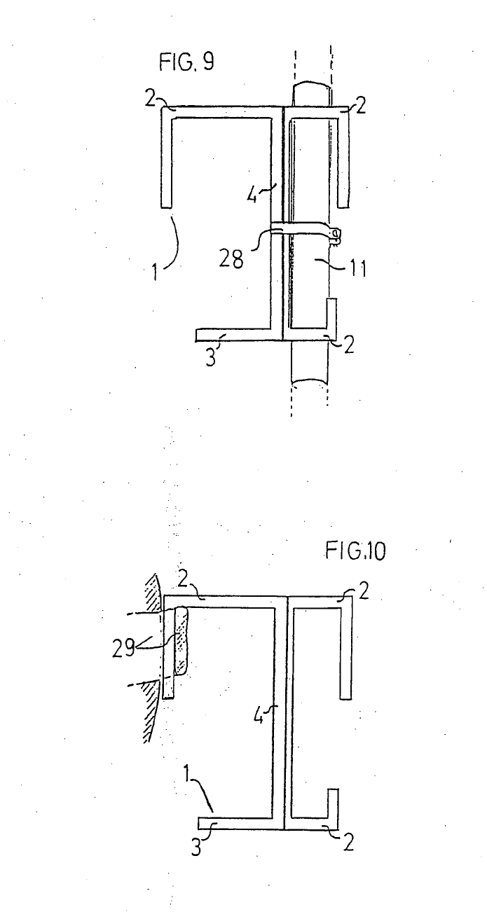

FIG. 9 shows one embodiment of a holding device 1 which is fixed on a tubular tool 11 or on which a tool 11 is fixed with a fastener 28.

The embodiment as shown in FIG. 10 shows how a holding device 1 can be hung on a lashing belt 29 or a belt.

FIG. 11 shows a cross sectional diagonal 30 of a rung 18 of a ladder on which the holding device 1 is fixed. This holding device 1 is attached relative to the cross sectional diagonal 30 by clamping, tilting, positively, or rigidly and thus protected against twisting, nonpositively or with locking capacity.

FIG. 12 shows the cross sectional diagonal 30 of a step of a stepladder 14,

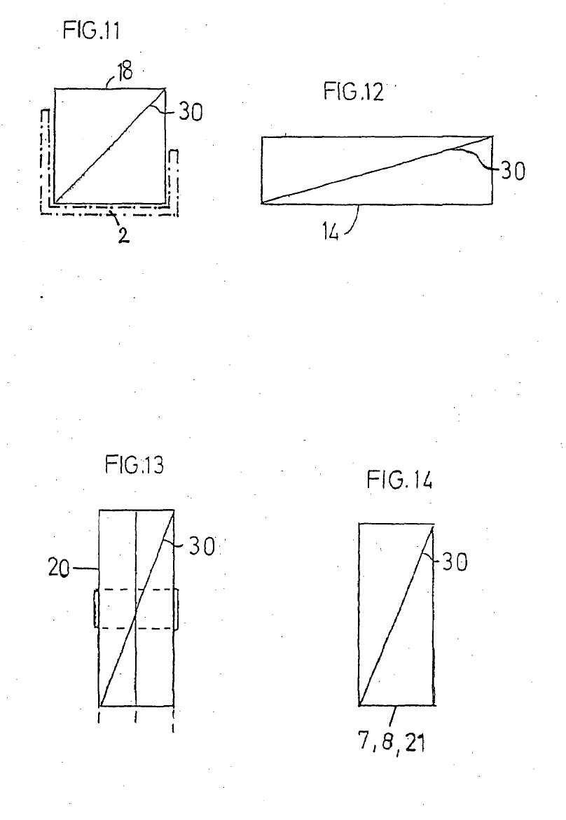

FIG. 13 shows the cross sectional diagonal 30 of the articulated region 20 of a ladder,

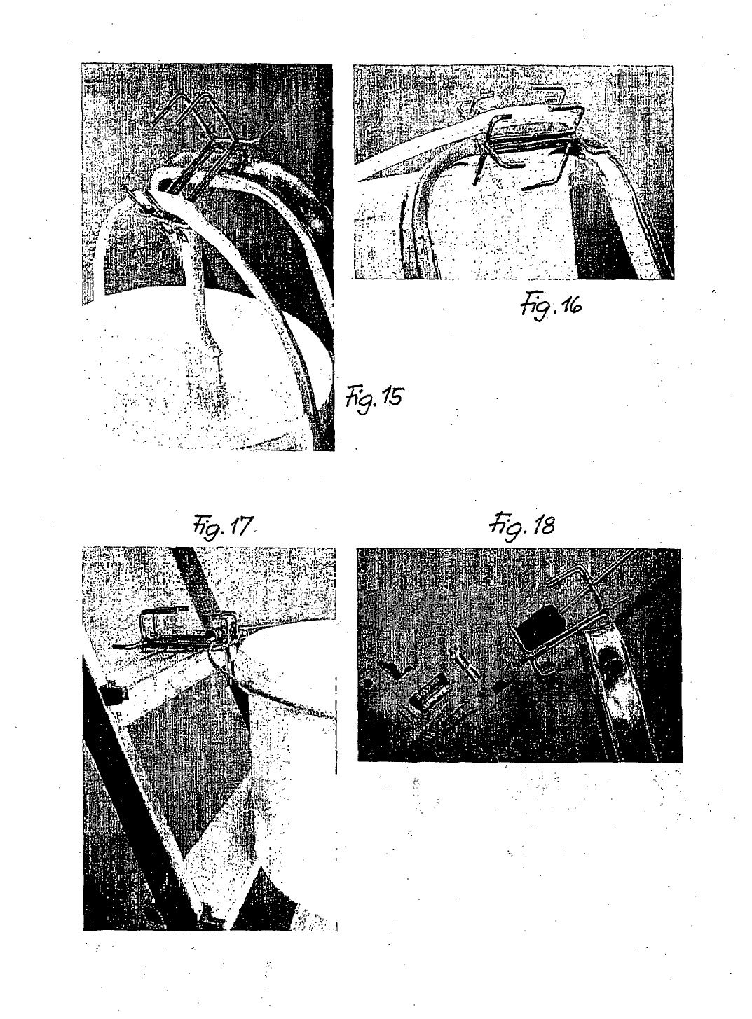

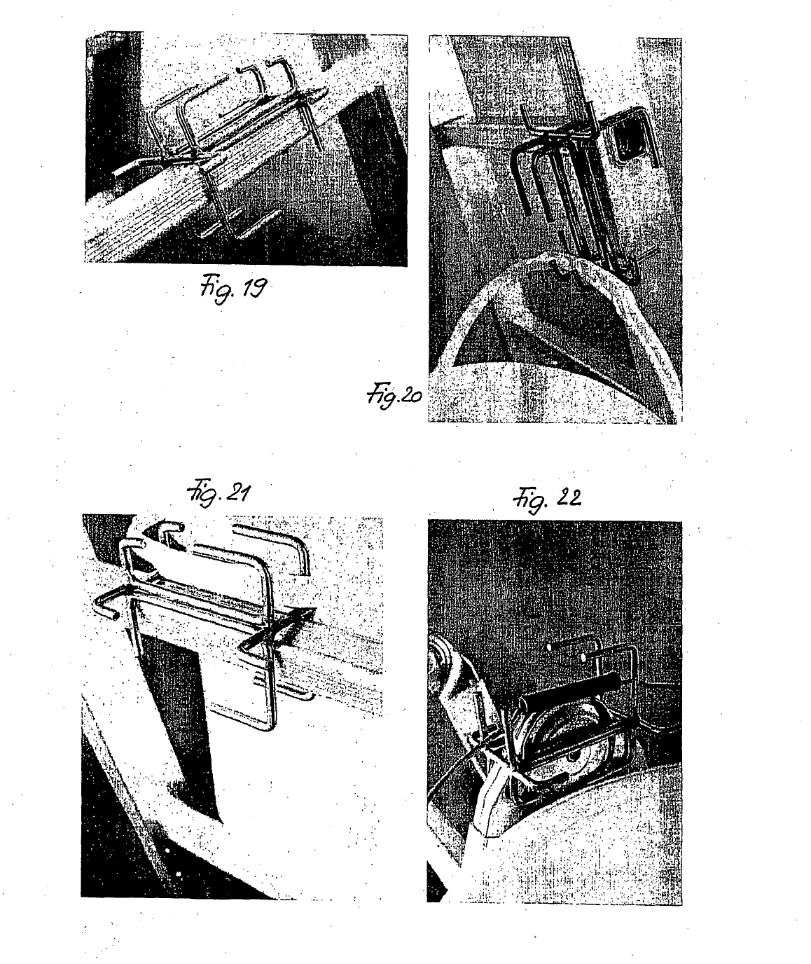

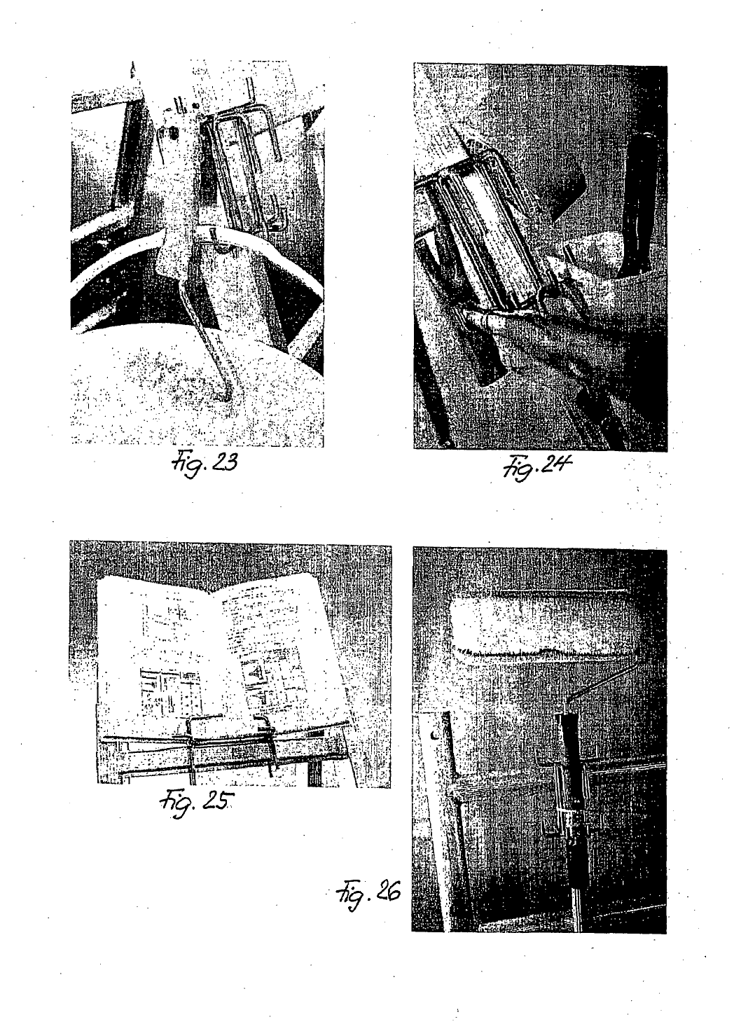

FIG. 14 shows a cross sectional diagonal of an intermediate part 7 or of a lateral stringer of a stepladder or a rung ladder 21.

The photographs in FIGS. 15-26 show various practical possible applications of the holding device as claimed in the invention in conjunction with ladder rungs, ladder stringers, etc., which can be fixed by tilting, clamping, encompassing, etc. against rotation with a ladder or the like without using a tool.

What is claimed is:

1. A multifunctional holding device for toolless attachment to frames, and for accommodation of working devices without fasteners, with rod-shaped, bar-shaped or plate-shaped holding parts, which have with one another to a frame-shaped structure with hook elements for hanging of the holding parts on the frame and for accommodating working devices, the hook-shaped elements coming into contact with the respective parts of the frame, and being supported on these parts, wherein
a) two multiple hook arrangements which are made in parallel planes and which are spaced apart from one another consist of one continuous horizontal middle rod each with an upper and a lower section with upper U-shaped hooks and lower U-shaped or L-shaped hooks made on the two rod ends,
b) the multi-hook arrangements each on the section of the planes which is pointed up and away from the middle rod have an open site between the opposing hook legs for insertion or attachment of the holding device on the frame, and
c) the two multi-hook arrangements on the face-side ends with the middle rods with cross connectors are rigidly attached to one another, the cross connectors and the middle rods forming further U-hooks.

2. A multifunctional holding device for toolless attachment to frames, and for accommodation of working devices without fasteners, with rod-shaped, bar-shaped or plate-shaped holding parts, which have with one another to a frame-shaped structure with hook elements for hanging of the holding parts on the frame and for accommodating working devices, the hook-shaped elements coming into contact with the respective parts of the frame, and being supported on these parts, wherein
a) a multiple hook arrangement which is made in one plane consists of a horizontal continuous middle rod with one upper front U-shaped hook and rear U-shaped hook made on the two rod ends and one lower front U-shaped hook and rear U-shaped hook made on the two rod ends, and
b) the multi-hook arrangement on the side of the plane which is pointed away from the middle rod in the upper and in the lower section has one open site each between the opposing hook legs and the hook sections for insertion or attachment of the holding device on the frame.

3. The holding device as claimed in claim 1, wherein cross connectors on their outside ends each have one L-shaped hook and wherein the free hook ends are arranged to run in the same direction.

4. The holding device as claimed in claim 1, wherein the multi-hook arrangements on the front and on the back end each have one U-shaped hook with free ends which are designed facing one another for hanging on the frame and for accommodation on working devices, with a base and free legs which selectively have the same or different length and which are made to run parallel to one another from the middle rods or slightly obliquely away from one another.

5. The holding device as claimed in claim 1, wherein the multi-hook arrangements in the lower section on the front end have a U-shaped hook with a base length which is greater than that of the overlying U-hook and on the back end have an L-shaped hook, the free leg having the same or different length than the base of the overlying U-hook.

6. The holding device as claimed in claim 4, wherein a distance of the free ends of the legs of the U-shaped hooks or of the U-hook and of the L-hook assigned to one another is designed and dimensioned with play according to the dimensions of the section of the frame or the like on which the holding device is fixed, and wherein the legs of the U-hooks are made to run parallel to one another or slightly obliquely away from one another.

7. The holding device as claimed in claim 4, wherein a distance of the hook legs located above and below the middle rod is dimensioned differently for matching to different dimensions of the frame parts, ladder steps, stringer, rungs, platforms, or lashing belts.

8. A holding device as claimed in claim 1, wherein the middle rod consists of two individual bars which are offset on top of and laterally to one another, one individual rod at a time being assigned to the upper section of the holding device or the other individual rod being assigned to the lower section.

9. A holding device as claimed in claim 1, wherein it is made and dimensioned to be able to be fixed protected from rotation and located in the cross sectional diagonals of a ladder step, a platform or the like and wherein the distance of the two legs of one hook is smaller than the diagonals of the frame part which engages it.

10. A holding device as claimed claim 1, wherein the holding device is produced from metal, hard plastic or comparable stable material of any cross section from flat bar steel, wire or combined materials in one or more parts, welded, riveted, cemented, screwed or the like.

11. A holding device as claimed in claim 1, wherein when using flat bar steel or flat holding elements for the holding device an additional connection to the frame is produced by means of a thumb screw connection.
